(19) United States
(12) Patent Application Publication
(10) Pub. No.: US 2024/0256419 A1
(43) Pub. Date: Aug. 1, 2024

(54) TOOLS FOR PERFORMANCE TESTING AUTONOMOUS VEHICLE PLANNERS

(71) Applicant: Five AI Limited, Cambridge (GB)

(72) Inventors: Bence Magyar, Cambridge (GB); Alejandro Bordallo, Cambridge (GB)

(73) Assignee: Five AI Limited, Cambridge (GB)

(21) Appl. No.: 18/564,340

(22) PCT Filed: May 27, 2022
(86) PCT No.: PCT/EP2022/064457

§ 371 Date: Nov. 27, 2023

(30) Foreign Application Priority Data
May 28, 2021 (GB) 2107646.8

(51) Int. Cl. G06F 11/34; G06F 11/36

(52) U.S. Cl. CPC G06F 11/3457; G06F 11/3664; G06F 11/3688; G06F 11/3692

(57) ABSTRACT

A computer implemented method of evaluating planner performance for an ego robot in a scenario, the method comprising: receiving for each of a set of runs, run evaluation data, wherein the run evaluation data for each run is generated by applying a planner in a scenario of that run to generate an ego trajectory taken by the ego robot in the scenario; determining for the set of runs, an examination category; generating for each run, an indicator of an examination parameter for that run in the examination category; the indicator selected from a group of different indicators in the examination category; and identifying a cluster of runs of the set of runs sharing the same indicator in the examination category.

### FIELD

The present disclosure relates to tools and techniques for testing the performance of autonomous vehicle planners, and methods, systems and computer programs for implementing the same.

### BACKGROUND

There have been major and rapid developments in the field of autonomous vehicles. An autonomous vehicle is a vehicle that is equipped with sensors and autonomous systems that enable it to operate without a human controlling its behaviour. The term autonomous herein encompass semi-autonomous and fully autonomously behaviour. The sensors enable the vehicle to perceive its physical environment, and may include for example cameras, radar and lidar. Autonomous vehicles are equipped with suitably programmed computers that are capable of processing data received from the sensors and making safe and predictable decisions based on the context that has been perceived by the sensors. There are different facets to testing the behaviour of the sensors and autonomous systems aboard a particular autonomous vehicle, or a type of autonomous vehicle. AV testing can be carried out in the real-world or based on simulated driving scenarios. An ego vehicle under testing (real or simulated) may be referred to as an ego vehicle.

One approach to testing in the industry relies on “shadow mode” operation. Such testing seeks to use human driving as a benchmark for assessing autonomous decisions. An autonomous driving system (ADS) runs in shadow mode on inputs captured from a sensor-equipped but human-driven vehicle. The ADS processes the sensor inputs of the human-driven vehicle, and makes driving decisions as if it were notionally in control of the vehicle. However, those autonomous decisions are not actually implemented, but are simply recorded with the aim of comparing them to the actual driving behaviour of the human. “Shadow miles” are accumulated in this manner typically with the aim of demonstrating that the ADS could have performed more safely or effectively than the human.

Existing shadow mode testing has a number of drawbacks. Shadow mode testing may flag some scenario where the available test data indicates that an ADS would have performed differently from the human driver. This currently requires a manual analysis of the test data. The “shadow miles” for each scenario need to be evaluated in comparison with the human driver miles for the same scenario.

### SUMMARY

The present inventors have noted that current testing techniques depend on a high level of manual intervention, on a scenario by scenario basis. As autonomous driving systems continue to improve, in many scenarios there is no significant difference between a human driver and an ADS. Therefore, significant manual effort can be expended on evaluating scenarios which are of no particular interest when attempting to improve an ADS.

The inventors have addressed a requirement for providing further insight into particular circumstances where attention is needed and may be fruitful in terms of improving an ADS. One circumstance may be a particular scenario. Another circumstance may be a particular system under test.

According to one aspect of the invention, there is provided a computer implemented method of evaluating planner performance for an ego robot in a scenario, the method comprising:
receiving for each of a set of runs, run evaluation data wherein the run evaluation data for each run is generated by applying a planner in a scenario of that run to generate an ego trajectory taken by the ego robot in the scenario;
determining for the set of runs an examination category;
generating for each run an indicator of an examination parameter for that run in the examination category;
the indicator selected from a group of different indicators in the examination category; and
identifying a cluster of runs of the set of runs sharing the same indicator in the examination category.

In some embodiments, the method may comprise rendering on a graphical user interface a visual representation of the indicators, each indicator having an associated visual indication which visually distinguishes it from other indicators in the examination category. In such embodiments, the method may further comprise assigning a unique run identifier to each run of the set of runs, the unique run identifier associated with a position in the visual representation. Identifying the cluster may comprise manual visual inspection of the visual representation.

In some embodiments, the group of indicators may comprise indicators at different quantisation levels of a quantitative value of the examination parameter. In such embodiments, each quantised level may be associated with a threshold value of the examination parameter.

The group of indicators may comprise a group of qualitative indicators.

In some embodiments, the method may comprise:
determining for each of the runs a second examination category;
generating for each run a respective indicator of an examination parameter of the second examination category for each run; and
identifying a second cluster of runs sharing the same indicator in the second category.

In such embodiments, the method may further include comparing the cluster with the second cluster to identify any runs in both the cluster and the second cluster.

In some embodiments, the category may be selected from location and driving conditions. In such embodiments, the method the examination parameter may be geographical location, and the category indicators may comprise run location identifiers.

The examination parameter may comprise scenario driving conditions, and the category may comprise driving conditions selected from residential, highway and unknown.

The examination parameter may comprise road rule compliance, and the category may comprise the extent to which road rule compliance has failed.

The examination parameter may comprise one or more performance metric, and the category may comprise the degree of performance improvement compared to a reference planner.

One way of carrying out a performance comparison is to use juncture point recognition as described in our UK Application no: GB2107645.0, the contents of which are incorporated by reference.

According to a second aspect, there is provided a computer program comprising a set of executable instructions, which when executed by a processor, cause a method according to the first aspect or any embodiment thereof to be performed.

According to a third aspect, there is provided a non-transitory computer readable medium sorting the computer program according to the second aspect.

According to a fourth aspect, there is provided an apparatus comprising a processor, and a code memory storing computer readable instructions, wherein the processor is configured to execute the computer readable instructions to: receive for each of a set of runs, run evaluation data, wherein the run evaluation data for each run is generated by applying a planner in a scenario of that run to generate an ego trajectory taken by the ego robot in the scenario; determine for the set of runs, an examination category; generate for each run, an indicator of an examination parameter for that run in the examination category, the indicator selected from a group of different indicators in the examination category; and identify a cluster of runs of the set of runs sharing the same indicator in the examination category.

In some embodiments, the processor is configured to execute the computer readable instructions to: render on a graphical user interface, a visual representation of the indicators, each indicator having an associated visual indication, which visually distinguishes it from other indicators in the examination category.

In some embodiments, the processor is configured to execute the computer readable instructions to: assign a unique run identifier to each run of the set of runs, the unique run identifier associated with a position in the visual representation.

In some embodiments, the processor is configured to execute the computer readable instructions to identify the cluster comprises manual visual inspection of the visual representation.

In some embodiments, the group of indicators comprises indicators at different quantisation levels of a quantitative value of the examination parameter.

In some embodiments, each quantised level is associated with a threshold value of the examination parameter.

In some embodiments, the group of indicators comprises a group of qualitative indicators.

In some embodiments, the processor is configured to execute the computer readable instructions to determine for each of the runs, a second examination category; generate for each run, a respective indicator of an examination parameter of the second examination category for each run; and identify a second cluster of runs sharing the same indicator in the second category.

In some embodiments, the processor is configured to execute the computer readable instructions to compare the cluster with the second cluster to identify any runs in both the cluster and the second cluster.

In some embodiments, the category is selected from location and driving conditions.

In some embodiments, the examination parameter is a geographical location, and the category indicators comprise run location identifiers.

In some embodiments, the examination parameter comprises scenario driving conditions, and the category comprises driving conditions selected from: residential; highway; and unknown.

In some embodiments, the examination parameter comprises road rule compliance, wherein the category comprises the extent to which road rule compliance has failed.

In some embodiments, the examination parameter comprises one or more performance metrics, and the category comprises the degree of performance improvement compared to a reference planner.

### BRIEF DESCRIPTION OF FIGURES

For a better understanding of the present invention and to show how the same may be carried into effect, reference will now be made by way of example to the accompanying drawings in which:

FIG. 1 shows a highly schematic block diagram of a runtime stack for an autonomous vehicle.

FIG. 2 shows a highly schematic block diagram of a testing pipeline for an autonomous vehicle's performance during simulation.

FIG. 3 shows a highly schematic block diagram of a computer system configured to test autonomous vehicle planners.

FIG. 4 shows part of an exemplary output report that provides an assessment of data from a set of runs compared against a reference planner.

FIG. 4A shows an exemplary performance card provided as part of the output report shown in FIG. 4.

FIG. 5 shows a summary part of an exemplary output report, in which points of interest in a set of run data are presented.

FIG. 6 shows a flow chart that demonstrates an exemplary method of comparing run data to evaluate potential for improvement.

FIG. 7 shows a highly schematic block diagram that represents an exemplary scenario extraction pipeline.

### DETAILED DESCRIPTION

### Example AV Stack

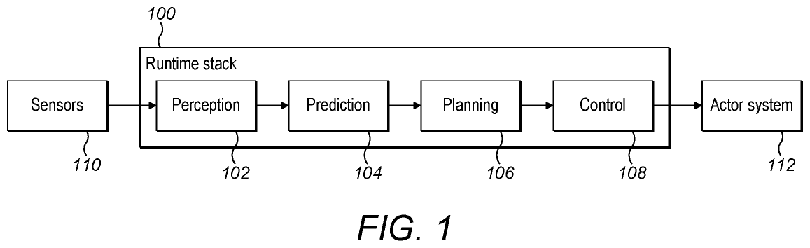

FIG. 1 shows a highly schematic block diagram of a runtime stack 100 for an autonomous vehicle (AV), also referred to herein as an ego vehicle (EV). The run time stack 100 is shown to comprise a perception system 102, a prediction system 104, a planner 106 and a controller 108.

In a real-world context, the perception system 102 would receive sensor inputs from an on-board sensor system 110 of the AV and uses those sensor inputs to detect external agents and measure their physical state, such as their position, velocity, acceleration etc. The on-board sensor system 110 can take different forms but generally comprises a variety of sensors such as image capture devices (cameras/optical sensors), lidar and/or radar unit(s), satellite-positioning sensor(s) (GPS etc.), motion sensor(s) (accelerometers, gyroscopes etc.) etc., which collectively provide rich sensor data from which it is possible to extract detailed information about the surrounding environment and the state of the AV and any external actors (vehicles, pedestrians, cyclists etc.) within that environment. The sensor inputs typically comprise sensor data of multiple sensor modalities such as stereo images from one or more stereo optical sensors, lidar, radar etc.

The perception system 102 comprises multiple perception components which co-operate to interpret the sensor inputs and thereby provide perception outputs to the prediction system 104.

External agents may be detected and represented probabilistically in a way that reflects the level of uncertainty in their perception within the perception system 102.

The perception outputs from the perception system 102 are used by the prediction system 104 to predict future behaviour of external actors (agents), such as other vehicles in the vicinity of the AV. Other agents are dynamic obstacles from the perceptive of the EV. The outputs of the prediction system 104 may, for example, take the form of a set of predicted of predicted obstacle trajectories.

Predictions computed by the prediction system 104 are provided to the planner 106, which uses the predictions to make autonomous driving decisions to be executed by the AV in a given driving scenario. A scenario is represented as a set of scenario description parameters used by the planner 106. A typical scenario would define a drivable area and would also capture any static obstacles as well as predicted movements of any external agents within the drivable area. A core function of the planner 106 is the planning of trajectories for the AV (ego trajectories) taking into account any static and/or dynamic obstacles, including any predicted motion of the latter. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner (not shown). In the following examples, a goal is defined by a fixed or moving goal location and the planner 106 plans a trajectory from a current state of the EV (ego state) to the goal location. For example, this could be a fixed goal location associated with a particular junction or roundabout exit, or a moving goal location that remains ahead of a forward vehicle in an overtaking context. A trajectory herein has both spatial and motion components, defining not only a spatial path planned for the ego vehicle, but a planned motion profile along that path. The planner 106 is required to navigate safely in the presence of any static or dynamic obstacles, such as other vehicles, bicycles, pedestrians, animals etc.

Returning to FIG. 1, within the stack 100, the controller 108 implements decisions taken by the planner 106. The controller 108 does so by providing suitable control signals to an on-board actor system 112 of the AV. At any given planning step, having planned an instantaneous ego trajectory, the planner 106 will provide sufficient data of the planned trajectory to the controller 108 to allow it to implement the initial portion of that planned trajectory up to the next planning step. For example, it may be that the planner 106 plans an instantaneous ego trajectory as a sequence of discrete ego states at incrementing future time instants, but that only the first of the planned ego states (or the first few planned ego states) are actually provided to the controller 108 for implementing.

In a physical AV, the actor system 112 comprises motors, actuators or the like that can be controlled to effect movement of the vehicle and other physical changes in the real-world ego state.

Control signals from the controller 108 are typically low-level instructions to the actor system 112 that may be updated frequently. For example, the controller 108 may use inputs such as velocity, acceleration, and jerk to produce control signals that control components of the actor system 112. The control signals could specify, for example, a particular steering wheel angle or a particular change in force to a pedal, thereby causing changes in velocity, acceleration, jerk etc., and/or changes in direction.

### Simulation Testing—Overview

Embodiments herein have useful applications in simulation-based testing. Referring to the stack 100 by way of example, in order to test the performance of all or part of the stack 100 though simulation, the stack is exposed to simulated driving scenarios. The examples below consider testing of the planner 106—in isolation, but also in combination with one or more other sub-systems or components of the stack 100.

In a simulated driving scenario, an ego agent implements decisions taken by the planner 106, based on simulated inputs that are derived from the simulated scenario as it progresses. Typically, the ego agent is required to navigate within a static drivable area (e.g. a particular static road layout) in the presence of one or more simulated obstacles of the kind a real vehicle needs to interact with safely. Dynamic obstacles, such as other vehicles, pedestrians, cyclists, animals etc. may be represented in the simulation as dynamic agents.

The simulated inputs are processed in exactly the same way as corresponding physical inputs would be, ultimately forming the basis of the planner's autonomous decision making over the course of the simulated scenario. The ego agent is, in turn, caused to carry out those decisions, thereby simulating the behaviours of a physical autonomous vehicle in those circumstances. In simulation, those decisions are ultimately realized as changes in a simulated ego state. There is this a two-way interaction between the planner 106 and the simulator, where decisions taken by the planner 106 influence the simulation, and changes in the simulation affect subsequent planning decisions. The results can be logged and analysed in relation to safety and/or other performance criteria.

Turning to the outputs of the stack 100, there are various ways in which decisions of the planner 106 can be implemented in testing. In “planning-level” simulation, the ego agent may be assumed to exactly follow the portion of the most recent planned trajectory from the current planning step to the next planning step. This is a simpler form of simulation that does not require any implementation of the controller 108 during the simulation. More sophisticated simulation recognizes that, in reality, any number of physical conditions might cause a real ego vehicle to deviate somewhat from planned trajectories (e.g. because of wheel slippage, delayed or imperfect response by the actor system, or inaccuracies in the measurement of the vehicle's own state 112 etc.). Such factors can be accommodated through suitable modelling of the ego vehicle dynamics. In that case, the controller 108 is applied in simulation, just as it would be in real-life, and the control signals are translated to changes in the ego state using a suitable ego dynamics model (in place of the actor system 112) in order to more realistically simulate the response of an ego vehicle to the control signals.

In that case, as in real life, the portion of a planned trajectory from the current planning step to the next planning step may be only approximately realized as a change in ego state.

### Example Testing Pipeline

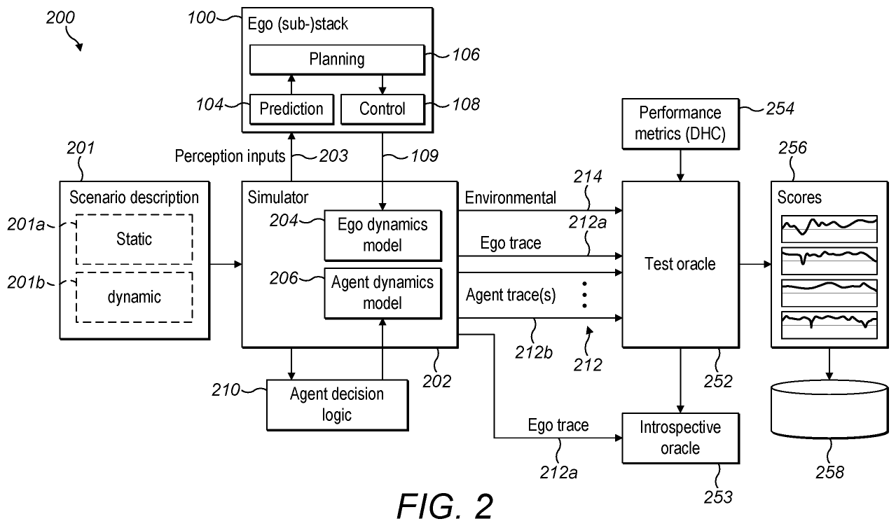

FIG. 2 shows a schematic block diagram of a testing pipeline 200. The testing pipeline is highly flexible and can be accommodate many forms of AV stack, operating at any level of autonomy. As indicated, the term autonomous herein encompasses any level of full or partial autonomy, from Level 1 (driver assistance) to Level 5 (complete autonomy).

The testing pipeline 200 is shown to comprise a simulator 202, a test oracle 252 and an ‘introspective’ oracle 253. The simulator 202 runs simulations for the purpose of testing all or part of an AV run time stack.

By way of example only, the description of the testing pipeline 200 makes reference to the runtime stack 100 of FIG. 1 to illustrate some of the underlying principles by example. As discussed, it may be that only a sub-stack of the run-time stack is tested, but for simplicity, the following description refers to the AV stack 100 throughout; noting that what is actually tested might be only a subset of the AV stack 100 of FIG. 1, depending on how it is sliced for testing. In FIG. 2, reference numeral 100 can therefore denote a full AV stack or only sub-stack depending on the context.

FIG. 2 shows the prediction, planning and control systems 104, 106 and 108 within the AV stack 100 being tested, with simulated perception inputs 203 fed from the simulator 202 to the stack 100.

The simulated persecution inputs 203 are used as a basis for prediction and, ultimately, decision-making by the planner 108. However, it should be noted that the simulated perception inputs 203 are equivalent to data that would be output by a perception system 102. For this reason, the simulated perception inputs 203 may also be considered as output data. The controller 108, in turn, implements the planner's decisions by outputting control signals 109. In a real-world context, these control signals would drive the physical actor system 112 of AV. The format and content of the control signals generated in testing are the same as they would be in a real-world context. However, within the testing pipeline 200, these control signals 109 instead drive the ego dynamics model 204 to simulate motion of the ego agent within the simulator 202.

A simulation of a driving scenario is run in accordance with a scenario description 201, having both static and dynamic layers 201a, 201b.

The static layer 201a defines static elements of a scenario, which would typically include a static road layout.

The dynamic layer 201b defines dynamic information about external agents within the scenario, such as other vehicles, pedestrians, bicycles etc. The extent of the dynamic information provided can vary. For example, the dynamic layer 201b may comprise, for each external agent, a spatial path to be followed by the agent together with one or both motion data and behaviour data associated with the path.

In simple open-loop simulation, an external actor simply follows the spatial path and motion data defined in the dynamic layer that is non-reactive i.e. does not react to the ego agent within the simulation. Such open-loop simulation can be implemented without any agent decision logic 210.

However, in “closed-loop” simulation, the dynamic layer 201b instead defines at least one behaviour to be followed along a static path (such as an ACC behaviour). In this, case the agent decision logic 210 implements that behaviour within the simulation in a reactive manner, i.e. reactive to the ego agent and/or other external agent(s). Motion data may still be associated with the static path but in this case is less prescriptive and may for example serve as a target along the path. For example, with an ACC behaviour, target speeds may be set along the path which the agent will seek to match, but the agent decision logic 110 might be permitted to reduce the speed of the external agent below the target at any point along the path in order to maintain a target headway from a forward vehicle.

The output of the simulator 202 for a given simulation includes an ego trace 212a of the ego agent and one or more agent traces 212b of the one or more external agents (traces 212). A trace is a complete history of an agent's behaviour within a simulation having both spatial and motion components. For example, a trace may take the form of a spatial path having motion data associated with points along the path such as speed, acceleration, jerk (rate of change of acceleration), snap (rate of change of jerk) etc.

Additional information is also provided to supplement and provide context to the traces 212. Such additional information is referred to as “environmental” data 214 which can have both static components (such as road layout) and dynamic components (such as weather conditions to the extent they vary over the course of the simulation).

To an extent, the environmental data 214 may be “passthrough” in that it is directly defined by the scenario description 201 and is unaffected by the outcome of the simulation. For example, the environmental data 214 may include a static road layout that comes from the scenario description 201 directly. However, typically the environmental data 214 would include at least some elements derived within the simulator 202. This could, for example, include simulated weather data, where the simulator 202 is free to change weather conditions as the simulation progresses. In that case, the weather data may be time-dependent, and that time dependency will be reflected in the environmental data 214.

The test oracle 252 receives the traces 212 and the environmental data 214, and scores those outputs against a set of predefined numerical metrics 254. The metrics 254 may encode what may be referred to herein as a “Digital Highway Code” (DHC) or digital driving rules. Some examples of other suitable performance metrics are given below.

The scoring is time-based: for each performance metric, the test oracle 252 tracks how the value of that metric (the score) changes over time as the simulation progresses. The test oracle 252 provides an output 256 comprising a score-time plot for each performance metric.

The metrics 254 are informative to an expert and the scores can be used to identify and mitigate performance issues within the tested stack 100.

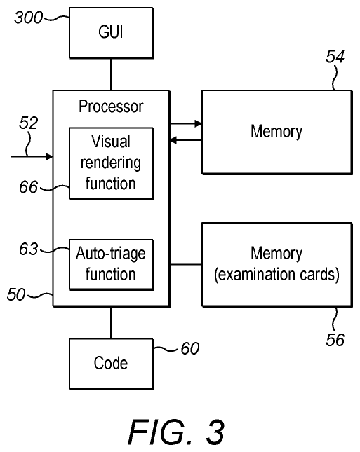

FIG. 3 is a schematic block diagram of a computer system configured to utilise information (such as the above metrics) from real runs or simulated runs taken by an ego vehicle. The system is referred to herein as the introspective oracle 253. A processor 50 receives data for generating insights into a system under test. The data is received at an input 52. A single input is shown, although it will readily be appreciated that any form of input to the introspective oracle may be implemented. In particular, it may be possible to implement the introspective oracle as a back-end service provided by a server, which is connected via a network to multiple computer devices which are configured to generate data and supply it to the introspective oracle. The processor 50 is configured to store the received data in a memory 54. Data is provided in the form of run data comprising “runs”, with their associated metrics, which are discussed further herein. The processor also has access to code memory 60 which stores computer executable instructions which, when executed by the processor 50, configure the processor 50 to carry out certain functions. The code which is stored in memory 60 could be stored in the same memory as the incoming data. It is more likely however that the memory for storing the incoming data will be configured differently from a memory 60 for storing code. Moreover, the memory 60 for storing code may be internal to the processor 50.

The processor 50 executes the computer readable instructions from the code memory 60 to execute a triaging function which may be referred to herein as an examination card function 63. The examination card function accesses the memory 54 to receive the run data as described further herein. Examination cards which are generated by the examination card function 63 are supplied to a memory 56. It will be appreciated that the memory 56 and the memory 54 could be provided by common computer memory or by different computer memories. The introspective oracle 253 further comprises a graphical user interface (GUI) 300 which is connected to the processor 50. The processor 50 may access examination cards which are stored in the memory 56 to render them on the graphical user interface 300 for the purpose further described herein. A visual rendering function 66 may be used to control the graphical user interface 300 to present the examination cards and associated information to a user.

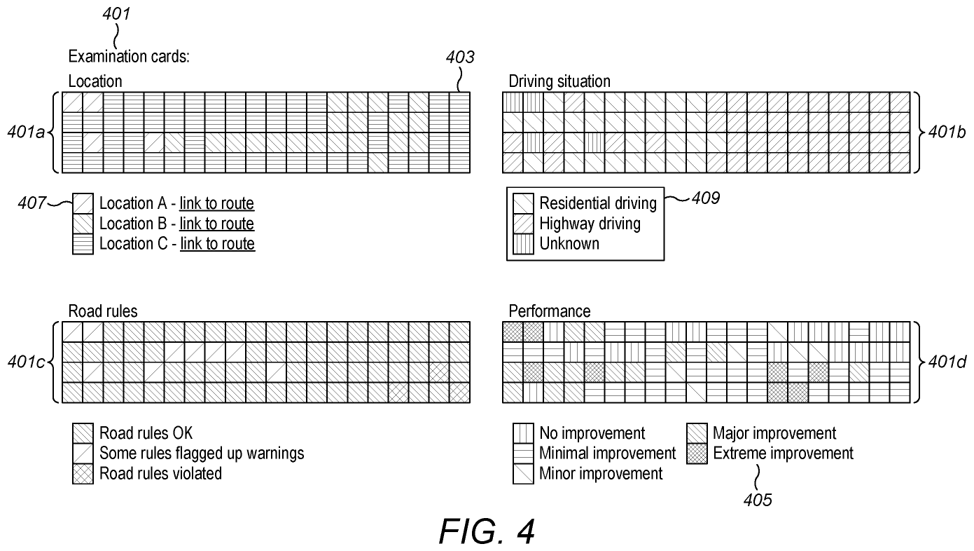

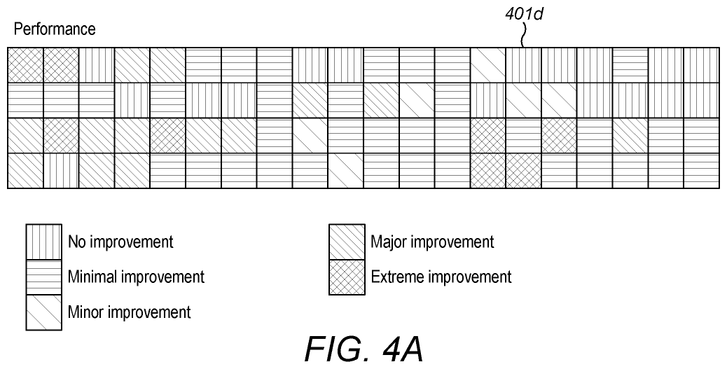

FIG. 4 shows part of an exemplary output report of the examination card function. FIG. 4 illustrates four examination cards 401a, 401b, 401c and 401d, each examination card 401 comprising a plurality of tiles 403, wherein each tile 403 provides a visual indication of a metric indicator for a respective different run. A run may be carried out in a simulated scenario or a real-world driving scenario, and each run may have an associated trace data set on which the examination card function analysis is performed. Each trace data set may include metadata, such as a run ID, that identifies which trace data set corresponds with which run. Each examination card 401 generates a visual representation which displays to a user an analysis of a set of runs. Each card represents a common metric of the runs. As a result, the number of metrics under which the runs are analysed is the same as the number of cards that are shown.

Each run is associated with the same tile position in every examination card 401. In the example of FIG. 4, a set of 80 runs are shown. In a particular card 401, each tile comprises an indicator selected from a group of indicators. A run may be analysed with respect to a particular examination metric to determine a metric value of the run. The particular tile associated with that run may then be assigned an indicator selected from the group of indicators based on the metric value. In some embodiments, the group of indicators may represent a qualitative metric, each indicator representing a category of the metric. In other embodiments, the group of indicators may represent a quantitative metric. Each indicator in the group may represent a quantisation level with respect to quantitative values of the examination metric associated with that particular card 401. In this case, each quantisation level may be associated with a threshold value of the metric. Each indicator has a qualitative or quantitative representation which is stored in association with that run for that card.

Each run may be subject to analysis under multiple metrics. For each metric analysed, a corresponding indicator may be generated, and the indicator represented in a tile of an examination card 401. The quantity of cards 401 therefore corresponds to the number of metrics under which each run is analysed. Tile positions within an examination card 401 will be referred to herein using coordinates such as T(a,b), where “a” is the tile row starting from the top of the card, and “b” is the tile column starting from the left. For example, coordinate T(1,20) would refer to the tile in the top right position in a card.

In an examination card 401, a tile may include a representation of the indicator assigned to that tile for the metric of that card 401; the representation may be a visual representation such as a colour. In a particular card 401, tiles which have been assigned the same indicator will therefore include the same representation of that indicator. If each indicator in the group of indicators for the metric of the card 401 is associated with a different visual representation, such as a colour, then tiles associated with a particular indicator will be visually distinguishable from the tiles which are not associated with that particular indicator.

Tiles with the same indicator in the same card represent a cluster 405. A cluster 405 is therefore a set of runs sharing a common indicator for the metric associated with the card. Each examination card 401 may identify one or more cluster 405. Runs in the same cluster may be identified by visual inspection by a user as being in the same cluster because they share a visual representation when displayed on the GUI 300. Alternatively, clusters may be automatically identified by matching the indicators to group tiles with a common indicator.

For each examination card, there may be an associated cluster key 409 generated by the processor and rendered on the GUI 300, which identifies the clusters 405 and their corresponding visual representations. A user may therefore quickly identify, by visual inspection, runs which have similar characteristics with respect to the metric of each examination card 401. As mentioned, an automated tool may be programmed to recognise where tiles share a common value and are therefore in a cluster 405. Tiles in a cluster 405 can indicate where a focus may be needed.

The system may be capable of multi-axis cluster recognition. A multi-axis cluster may comprise a quantity of runs which are in the same cluster in multiple examination cards 401. That is, a multi-axis cluster comprise runs which are similar with respect to multiple metrics. A first examination card 401a is a location card. The location card 401a comprises 80 tiles, each tile representing a different run. For each run, a location indicator has been generated and assigned to the corresponding tiles. The location indicator can be identified in the run data when it is uploaded to the introspective oracle 253, or can be inferred from data gathered during the run. In the example of FIG. 4, each run in the set of 80 runs has taken place in one of three locations, where a location may be, but is not limited to being, a town, city or driving route in which a run took place. Each location indicator for the location metric may be associated with a visual representation. Each tile in the location card may comprise the visual representation corresponding to the location indicator of its associated run. For example, tiles may be rendered as a particular colour, the particular colour being the visual representation associated with the indicator of that tile.

Runs which share the same location value may then be identified as being in a cluster 405. For example, the runs in positions T(1,1), T(1,2), T(3,2) and T(3,5) of location card 401a are represented by brown tiles which, as seen in the cluster key 409 associated with the location card 401a, identifies those runs as taking place in “Location A.”

A second examination card 401b is a driving situation card. The driving situation card 401b comprises 80 tiles, each tile position representing the same run as in the corresponding tile position on the location card 401a. For each run, a situation indicator has been generated and assigned to the corresponding tiles. The situation indicator can be identified in the run data when it is uploaded to the introspective oracle 253, or can be inferred from data gathered during the run. In the example of FIG. 4, each run has taken place in one of three driving situations: “residential,” “highway,” or “unknown.” Each driving situation may have a corresponding situation value, each run being assigned the situation value corresponding to the situation in which the run took place. Each situation indicator for the situation metric may be associated with a visual representation. Each tile in the situation card may include the visual representation corresponding to the situation indicator of its associated run. For example, tiles may be rendered as a particular colour, the particular colour being the visual representation associated with the situation indicator of that tile.

For example, the runs in positions T(1,1), T(1,2), T(3,2) and T(3,5) of the driving situation card 401b are represented by grey tiles which, as seen in the cluster key 409 associated with the situation card 401b, identifies those runs as taking place in an “unknown” driving situation. The cards 401a and 401b are associated with qualitative situation or context metrics of the run scenarios. The following described examination cards, 401c and 401d, are associated with outcome metrics, which assess outcomes evaluated during a run, such as a road rule failure by the test oracle as described earlier.

A third examination card 401c is a road rules card. Road rules card 401c comprises 80 tiles, each tile position representing the same run as in the corresponding tile position on the location card 401a and the driving situation card 401b. Each run is assigned a road rules indicator from a predetermined group of road rules indicators. Each indicator in the group thereof may represent a quantisation level with respect to the road rules metric. In the example of FIG. 4, the quantisation levels for the road rules card 401c are: “road rules OK,” “some rules flagged warnings,” and “road rules violated.” Each road rules indicator may also be associated with a visual representation 407. Each tile in the road rules card may include the visual representation 407 corresponding to the road rules indicator of its associated run. For example, tiles may be rendered as a particular colour, the particular colour being the visual representation associated with the road rules indicator of that tile.

For example, the runs in positions T(3,19), T(4,17) and T(4,20) of road rules card 401c are represented by red tiles which, as seen in the cluster key 409 associated with the road rules card 401c, indicates that those runs included at least one road rule violation.

A fourth examination card 401d is a performance card. The performance card 401d comprises 80 tiles, each tile position representing the same run as in the corresponding tile position on the location card 401a, the driving situation card 401b and the road rules card 401c. The clusters associated with the performance card differentiate each run based on the extent to which each run is susceptible of improvement. The visual indicators 407 of the performance card 401d define a scale with which a user can visually identify the improvement potential of each run. For example, a dark green, light green, blue, orange or red tile would respectively indicate that the associated run is susceptible of no improvement, minimal, minor, major, or extreme improvement. The performance card is described in more detail later.

Further, the described report may be presented to a user by displaying it on the graphical user interface (GUI) 300. Each tile 403 in an examination card 401 may be a selectable feature which, when selected on the GUI 300, opens a relevant page for the associated run. For example, selecting a tile 403 in the road rules card 401c may open a corresponding introspective oracle evaluation page. The above described report may be received, for example, by email. Users may receive a report as an interactive file through which they can access introspective oracle pages or other relevant data.

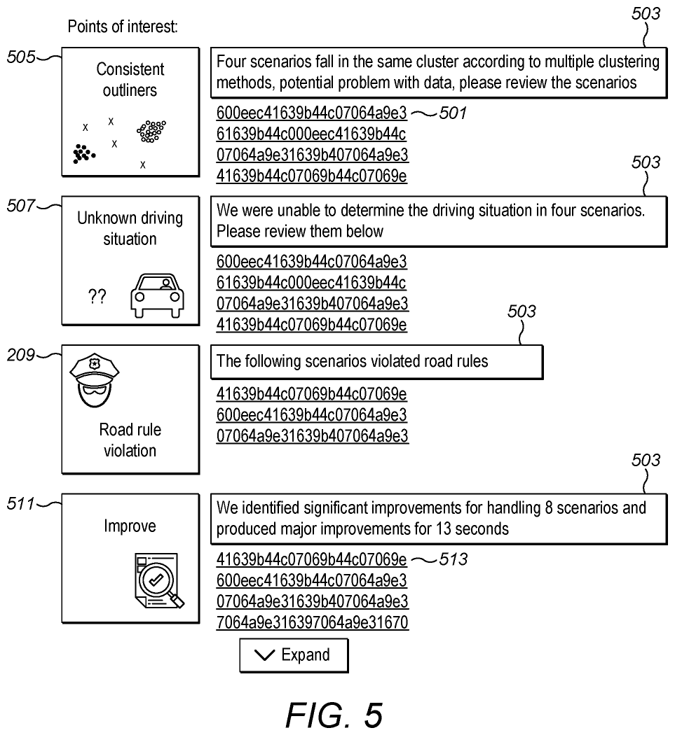

FIG. 5 shows another part of an exemplary output report of the triaging function. FIG. 5 shows a summary section includes four “points of interest” categories, each category in the summary section including a unique identifier 501 to each run in that category and a description of why the runs are of interest. The unique identifier 501 may be a hashed name.

FIG. 5 includes a point of interest category entitled “consistent outliers,” the consistent outliers category 505 including a category description 503 and a quantity of unique identifiers 501. In the consistent outliers category 505, the system has identified four runs which are in the same cluster 405 as one another according to multiple clustering methods or analysis types. That is, the system has identified four runs for which there is a congruency of clustering over multiple examination cards 401. In the consistent outliers category 505, the system has identified a multi-axis cluster, as has been described with reference to FIG. 4.

For example, with reference to FIG. 4, note that the runs associated with tile positions T(1,1), T(1,2), T(3,2) and T(3,5) are in the same cluster as one another in all of cards 401a, 401b, 401c and 401d. Therefore, according to the cluster keys 409 for each examination card 401, all four of the referenced cards took place in “Location A” under “unknown” driving conditions, flagged some road rule warnings and were found to be susceptible of extreme improvement when compared to a reference planner. The reference planner may be coupled with other components, such as a prediction system, and used to generate “ground-truth” plans and trajectories for comparison with the target SUT. The reference planner may be capable of providing an almost theoretically ideal plan, allowing an assessment of how much improvement could be made in theory, for example by using resources such as computer resources or time which would not normally be available to a ‘real life’ planner.

The unique identifiers 501 in the consistent outliers category 505 of FIG. 5 may therefore correspond to the runs in positions T(1,1), T(1,2), T(3,2) and T(3,5) of the examination cards 401 of FIG. 4. The category description 503 for the consistent outliers category 505 also includes a suggestion as to why the cluster congruency has occurred, suggesting in the example of FIG. 5 that there is a potential problem with the data.

The summary section of FIG. 5 also includes an “unknown driving situation” category 507, the unknown driving situation category 507 including a category description 503 and a quantity of unique identifiers 501. In the unknown driving situation category 507, the system has provided unique identifiers 501 corresponding to runs for which no driving situation has been determined, as explained by the associated category description 503. The category description 503 of the unknown driving situation category 507 also includes a suggestion that the user review the runs. Each unique identifier 501 provided in a points of interest category in the summary section may also be a selectable feature which, when selected on a GUI 300, opens a relevant page for the associated run. For example, selection of a unique identifier 501 in the unknown driving situation category 507 may open a user interface through which a user can visualise the referenced run. In some points of interest categories, selection of a run reference 501 may instead open a corresponding test oracle page, or an introspective oracle reference planner comparison page.

The summary section of FIG. 5 also includes a “road rule violation” category 509, the road rule violation category 509 including a category description 503 and a quantity of unique identifiers 501. In the road rule violation category 509, the system has identified and provided unique identifiers 501 corresponding to the runs in which a road rule was violated. There are three provided run references 501 in FIG. 5, the three references 501 corresponding to the three runs in the red cluster of the road rules card 401c of FIG. 4.

The summary section of FIG. 5 also includes an “improve” category 511, the improve category 511 including a category description 503 and a quantity of run references 501. In the improve category 509, the system has identified and provided unique identifiers 501 corresponding to the runs that are susceptible of extreme improvement. There are 8 runs identified in the performance card 401d of FIG. 4 that are in the red “extreme improvement” cluster. The improve category 511 of FIG. 5 shows four run references 501 corresponding to four of the 8 relevant runs. The improve category 511 also includes a selectable “expand” feature 513 which, when selected on a GUI 300, may allow a user to view a full list of relevant run references 501.

An illustration of the visual rendering of a performance card is shown in FIG. 4A. The performance card shown in FIG. 4A is denoted by reference numeral 401d and comprises 80 tiles, each tile position representing a particular ‘run’. Each tile is associated with a visual indication (for example a colour) by means of which a user can visually identify the improvement potential for each run. For example, the colours dark green, light green, blue, orange or red may be utilized to represent each of five different categories of improvement potential for the run. Dark green may indicate that the run is susceptible of no improvement, light green that it is susceptible of minimal improvement, blue that it is susceptible of minor improvement, orange that it is susceptible of major improvement or red that it is susceptible of extreme improvement.

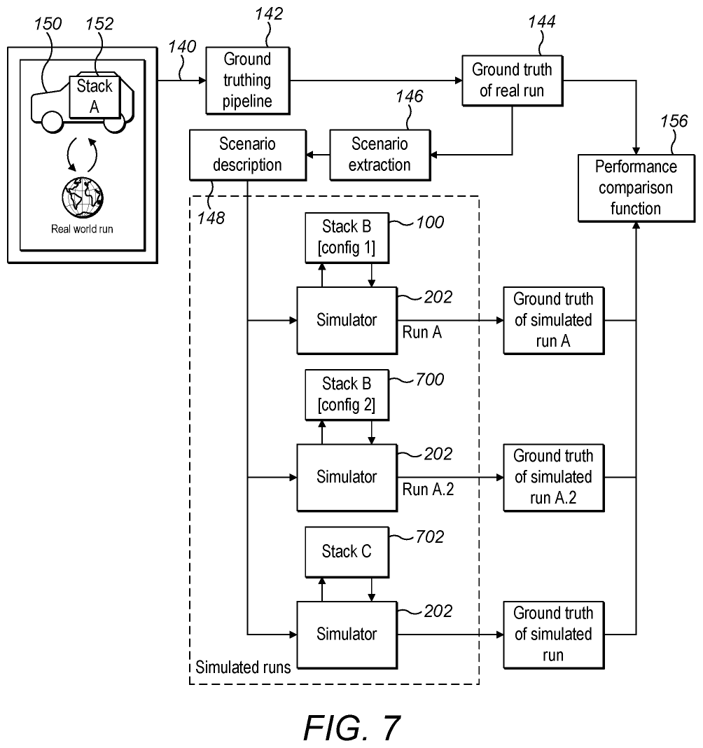

The manner in which these visual indications are determined is described in more detail in the following. When the performance card is rendered to a user on a graphical user interface, a user may select a particular tile, for example based on the visual indication (colour) of that tile. When a tile is selected, details of the potential performance improvement may be displayed to the viewer on the graphical user interface. In certain embodiments, an interactive visualization with metrics and automated analysis of the results may be presented to aid a user in understanding the reasons for indicating a certain level of potential performance improvement. The performance card is particularly useful in enabling a user to understand the performance of his planning stack (or certain portions of his planning stack). For this application, details of a user run are required. FIG. 7 shows a highly schematic block diagram of a scenario extraction pipeline. Run data 140 of a real-world run is passed to a ground truthing pipeline 142 for the purpose of generating scenario ground truth. The run data 140 could comprise for example sensor data and/or perception outputs captured/generated onboard one or more vehicles (which could be autonomous, human driven or a combination thereof), and/or data captured from other sources such as external sensors (CCTV etc.). As shown in FIG. 7, the run data 140 is shown provided from an autonomous vehicle 150 running a planning stack 152 which is labelled stack A. The run data is processed within the ground truthing pipeline 142 in order to generate appropriate ground truth 144 (trace(s) and contextual data) for the real-world run. The ground truthing process could be based on manual annotation of the raw run data 142 or the process could be entirely automated (e.g. using offline perception methods), or a combination of manual and automated ground truthing could be used. For example, 3D binding boxes may be placed around vehicle and/or other agents captured in the run data 140 in order to determine spatial and motion states of their traces. A scenario extraction component 146 receives the scenario ground truth 144 and processes the scenario ground truth to extract a more abstracted scenario description 148 that can be used for the purpose of simulation. The scenario description is supplied to the simulator 202 to enable a simulated run to be executed. In order to do this, the simulator 202 may utilize a stack 100 which is labelled stack B, config 1. The relevance of this is discussed in more detail later. Stack B is the planner stack, which is being used for comparison purposes, to compare its performance against the performance of stack A, which was run in the real run. Stack B could be for example a reference planner stack, as described further herein. Note that the run output from the simulator is generated by planner stack B using the ground truth contained in the scenario which was extracted from the real run. This maximizes the ability for planner stack B to perform as well as possible.

The run data from the simulation is supplied to a performance comparison function 156. The ground truth actual run data is also supplied to the performance comparison function 156. The performance comparison function 156 determines whether there is a difference in performance between the real run and the simulated run. This may be done in a number of different ways, as further described herein. One novel technique discussed herein and discussed in UK patent application no: GB2107645.0 is juncture point recognition. The performance difference of the runs is used to generate a visual indication for the tile associated with this run in the performance card. If there was no difference, a visual indication indicating that no improvement has been found is provided (for example, dark green). This means that the comparison system has failed to find any possible improvement for this scenario, even when run against a reference planner stack. This means that the original planner stack A performed as well as it could be expected to, or that no significant way could be found to improve its performance. This information in itself is useful to a user of stack A.

If a significant difference is found in the performance between the real run and the simulated run, an estimate may be made of how much the performance could be improved. A visual indication is provided for each level of estimate in a quantized estimation scale.

As illustrated in FIG. 7, there may be more than one simulation run performed in order to get a performance improvement reference. There may multiple different planner solutions that can be run in simulation on this particular scenario, and the best performing of them may be the one against which the performance of stack A is compared to generate the visual indication on the card. For example, as shown in FIG. 7, a simulated run could be using the simulator 202 using stack B config 2 700, (that is, the same stack as in the first simulation but with the different configuration of certain parameters), or it could be run with a different stack, for example labelled stack C 702.

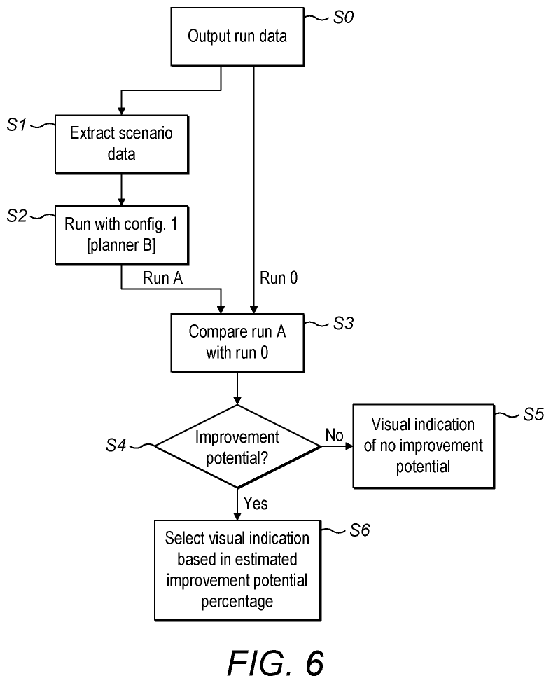

An exemplary workflow is shown in FIG. 6. At step S0, the output run data 140 is provided. At Step S1, scenario data is extracted from the output run data as herein described. At Step S2, the extracted scenario data is run in the simulator using planner stack B (possibly in a certain configuration, config 1). The output of the simulator is labelled run A in FIG. 6. The real world run data is labelled run 0 in FIG. 6. At step S3, the data of run A is compared with the data of run 0 to determine the difference in performance between the runs. At step S4, it is determined whether or not there is any potential for improvement, based on the difference in performance. If there is not, a visual indication indicating no improvement potential is provided at step S5. If there is improvement potential, an estimate of the improvement potential is generated, and the visual indication selected based on that estimate at step S6.

As mentioned, one possible technique for comparing performance is to use juncture point recognition. When a juncture is identified, it is possible to identify either semi, automatically or fully automatically how the performance may be improved. In certain embodiments, this may be performed by “input ablation”. The term “input ablation” is used herein to denote analysis of a system by comparing it with the same system but with a modification to reconfigure it. Specifically, the reconfiguring can involve removing some aspect of the system or some performance element of the system. For example, it is possible to use perception input ablation, in which case the performance of a stack is analysed without relying on ground truth perception. Instead, realistic perception data is utilized, with the expectation that this will show a lower performance.

A specific example of perception input ablation is discussed further herein. As explained above with reference to FIG. 7, run A is generated utilizing planner stack B based on ground truth data. The base extracted scenario data may be used to generate a different run using a different simulation configuration, for example as labelled planner B, config 2 in FIG. 7. This simulation configuration may model realistic perception and then reproduce typical perception errors seen in the real world. The output of this is labelled Run A.2 in FIG. 7. Then, run A may be compared with run A.2 in the comparison function 156 to determine if there is a performance difference. When using juncture point recognition, the comparison can determine if there is a juncture in performance. If there is no juncture, it is possible to assert that perception errors were not related to the performance improvement of run 0 vs run A, so therefore there is no need to proceed with any further perception ablation investigation. If there is a juncture, and run A.2 performance is worse than run A, then it is possible to assert that perception errors may have had something to do with the difference in performance between run A and run 0, and therefore it may be worth carrying out further investigation along this line.

Other forms of “ablation” may be utilized to allow a user to be assisted in determining when a line of investigation may be helpful or not. For example, certain prediction parameters may be ablated. In another example, resource constraints may be modified, for example, limits may be imposed on the processing resource, memory resource or operating frequency of the planning stack.

Ablation may be performed in a binary (on/off) manner for example as described in our PCT patent application PCT/EP2020/073563, the contents of which are incorporated by reference. This PCT application provides an approach to simulation-based safety testing using what are referred to herein as “Perception Statistical Performance Models” (PSPMs). PSPMs model perception errors in terms of probabilistic uncertainty distributions, based on a robust statistical analysis of actual perception outputs computed by a perception component or components being modelled. A unique aspect of PSPMs is that, given a perception ground truth (i.e. a “perfect” perception output that would be computed by a perfect but unrealistic perception component), a PSPM provides a probabilistic uncertainty distribution that is representative of realistic perception components that might be provided by the perception component(s) it is modelling. For example, given a ground truth 3D bounding box, a PSPM which models a PSPM modelling a 3D bounding box detector will provide an uncertainty distribution representative of realistic 3D object detection outputs. Even when a perception system is deterministic, it can be usefully modelled as stochastic to account for epistemic uncertainty of the many hidden variables on which it depends on practice.

Perception ground truths will not, of course, be available at runtime in a real-world AV (this is the reason complex perception components are needed that can interpret imperfect sensor outputs robustly). However, perception ground truths can be derived directly from a simulated scenario run in a simulator. For example, given a 3D simulation of a driving scenario with an ego vehicle (the simulated AV being tested) in the presence of external actors, ground truth 3D bounding boxes can be directly computed from the simulated scenario for the external actors based on their size and pose (location and orientation) relative to the ego vehicle. A PSPM can then be used to derive realistic 3D bounding object detection outputs from those ground truths, which in turn can be processed by the remaining AV stack just as they would be at runtime.

A PSPM for modelling a perception slice of a runtime stack for an autonomous vehicle or other robotic system may be used e.g. for safety/performance testing. A PSPM is configured to receive a computed perception ground truth, and determine from the perception ground truth, based on a set of learned parameters, a probabilistic perception uncertainty distribution, the parameters learned from a set of actual perception outputs generated using the perception slice to be modelled. A simulated scenario is run based on a time series of such perception outputs (with modelled perception errors), but can also be re-run based on perception ground truths directly (without perception errors). This can, for example, be a way to ascertain whether perception error was the cause of some unexpected decision within the planner, by determining whether such a decision is also taken in the simulated scenario when perception error is “switched off”.

The examples discussed in the present disclosure enables at each juncture an interactive visualization to be indicated to a user with metrics and automated analysis of the results to aid the user in understanding between the two runs which are being compared, for example:
1. What is the causal difference?
2. What is the performance difference?

As already mentioned, while two scenarios have been utilized two runs have been used for ease of explanation, a user may be comparing multiple scenarios in a multidimensional performance comparison against multiple planner stacks/input ablations/original scenarios.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or 10 embodiments, or any combination of any other of the examples or embodiments. Furthermore, equivalents and modifications not described herein may also be employed within the scope of the invention, which is defined in the claims.

1. A computer implemented method of evaluating planner performance for an ego robot in a scenario, the method comprising:
receiving for each of a set of runs, run evaluation data, wherein the run evaluation data for each run is generated by applying a planner in a scenario of that run to generate an ego trajectory taken by the ego robot in the scenario;
determining for the set of runs, an examination category;
generating for each run, an indicator of an examination parameter for that run in the examination category, the indicator selected from a group of different indicators in the examination category; and
identifying a cluster of runs of the set of runs sharing the same indicator in the examination category.

2. The method according to claim 1, comprises rendering on a graphical user interface a visual representation of the indicators, each indicator having an associated visual indication, which visually distinguishes it from other indicators in the examination category.

3. The method according to claim 2, comprising assigning a unique run identifier to each run of the set of runs, the unique run identifier associated with a position in the visual representation.

4. The method according to claim 3, wherein identifying the cluster comprises manual visual inspection of the visual representation.

5. The method according to claim 1, wherein the group of indicators comprises indicators at different quantisation levels of a quantitative value of the examination parameter.

6. The method according to claim 5, wherein each quantised level is associated with a threshold value of the examination parameter.

7. The method according to claim 1, wherein the group of indicators comprises a group of qualitative indicators.

8. The method according to claim 1, comprising:
determining for each of the runs, a second examination category;
generating for each run, a respective indicator of an examination parameter of the second examination category for each run; and
identifying a second cluster of runs sharing the same indicator in the second category.

9. The method according to claim 8, further comprising: comparing the cluster with the second cluster to identify any runs in both the cluster and the second cluster.

10. The method according to claim 1, wherein the category is selected from location and driving conditions.

11. The method according to claim 8, wherein the examination parameter is a geographical location, and the category indicators comprise run location identifiers.

12. The method according to claim 1, wherein the examination parameter comprises scenario driving conditions, and the category comprises driving conditions selected from:
residential;
highway; and
unknown.

13. The method according to claim 1, wherein the examination parameter comprises road rule compliance, wherein the category comprises the extent to which road rule compliance has failed.

14. The method according to claim 1, wherein the examination parameter comprises one or more performance metrics, and the category comprises the degree of performance improvement compared to a reference planner.

15. An apparatus comprising a processor, and a code memory storing computer readable instructions, wherein the processor is configured to execute the computer readable instructions to:
receive for each of a set of runs, run evaluation data, wherein the run evaluation data for each run is generated by applying a planner in a scenario of that run to generate an ego trajectory taken by the ego robot in the scenario;
determine for the set of runs, an examination category;
generate for each run, an indicator of an examination parameter for that run in the examination category, the indicator selected from a group of different indicators in the examination category; and
identify a cluster of runs of the set of runs sharing the same indicator in the examination category.

16. A computer program comprising a set of executable instructions, which when executed by a processor, cause a method to be performed, the method comprising:
receiving for each of a set of runs, run evaluation data, wherein the run evaluation data for each run is generated by applying a planner in a scenario of that run to generate an ego trajectory taken by the ego robot in the scenario;
determining for the set of runs, an examination category;
generating for each run, an indicator of an examination parameter for that run in the examination category, the indicator selected from a group of different indicators in the examination category; and
identifying a cluster of runs of the set of runs sharing the same indicator in the examination category.

17. The apparatus according to claim 16, wherein the processor is configured to render on a graphical user interface a visual representation of the indicators, each indicator having an associated visual indication, which visually distinguishes it from other indicators in the examination category.

18. The apparatus according to claim 16, wherein the processor is configured to assign a unique run identifier to each run of the set of runs, the unique run identifier associated with a position in the visual representation.

19. The apparatus according to claim 15, wherein the group of indicators comprises indicators at different quantisation levels of a quantitative value of the examination parameter.

20. The apparatus according to claim 19, wherein each quantised level is associated with a threshold value of the examination parameter.
